(19) United States
(12) Patent Application Publication
(10) Pub. No.: US 2018/0374057 A1
(43) Pub. Date: Dec. 27, 2018

(54) INTERACTION WITH AND VISUALIZATION OF CONFLICTING CALENDAR EVENTS

(71) Applicant: MICROSOFT TECHNOLOGY LICENSING, LLC, Redmond, WA (US)

(72) Inventor: Archil VARDIDZE, Kirkland, WA (US)

(73) Assignee: MICROSOFT TECHNOLOGY LICENSING, LLC, Redmond, WA (US)

(21) Appl. No.: 15/630,103

(22) Filed: Jun. 22, 2017

(51) Int. Cl. G06Q 10/10; G06F 3/0485; G06F 3/0488; G06F 3/01

(52) U.S. Cl. CPC G06Q 10/1095; G06F 3/013; G06F 3/0488; G06F 3/0485

(57) ABSTRACT

Technologies are described for visualization of conflicting calendar events to enhance interactivity and prevent interaction accuracy reduction. In some examples, a number calendar events conflicting at least partially over a time period to be displayed on a calendar view may be determined based on an interactivity parameter. The interactivity parameter may include legibility, intractability, etc. If conflicting calendar events higher than the number that can be displayed is detected, an indication of more calendar events being available such as a partial calendar event display may be provided. Users may be allowed to scroll horizontally or vertically over the conflicting calendar events to see ones that are not initially displayed in a visible portion of the calendar view.

### BACKGROUND

Calendar applications have become much more than a scheduling tool. Modern calendar applications provide a multi-functional platform for organizing and facilitating appointments, tasks, online or physical meetings, etc. As such, an increasing number of rely on calendar applications to organize their personal and business lives. When a user has multiple calendar events overlapping within a same time period, conventional calendar applications display the conflicting calendar events squeezed together. Thus, depending on a scenario, a user may find difficult to read or understand which representation belongs to which calendar event. The legibility of the calendar event representations on a calendar view may become even worse on smaller display areas such as mobile devices. Furthermore, as the conflicting calendar events are reduced in size, interaction accuracy may also decrease.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to visualization of conflicting calendar events to enhance interactivity and prevent interaction accuracy reduction. In some examples, two or more calendar events that conflict over a time period may be detected. A display size for the two of more conflicting calendar events may be determined based on an interactivity parameter, where the interactivity parameter defines a minimum size to legibility or interactivity, for example. The two or more calendar events may then be presented on a calendar user interface by using the determined display size, providing an indication of additional calendar event information outside a visible portion of the calendar view, and allowing a scroll action to the additional calendar event information outside a visible portion of the calendar view.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a display diagram illustrating an example network environment where a system for visualization of conflicting calendar events may be implemented;

FIG. 2 includes a display diagram illustrating conceptually an example set of actions for visualization of conflicting calendar events;

FIG. 3 includes a display diagram illustrating an example calendar user interface showing horizontal scroll based visualization of conflicting calendar events;

FIGS. 4A and 4B include display diagrams illustrating example calendar user interfaces with different features of horizontal scroll based visualization of conflicting calendar events;

FIG. 5 includes a display diagram illustrating an example calendar user interface showing vertical scroll based visualization of conflicting calendar events;

FIG. 6 is a networked environment, where a system according to embodiments may be implemented;

FIG. 7 is a block diagram of an example computing device, which may be used for visualization of conflicting calendar events; and

FIG. 8 illustrates a logic flow diagram of a method to implement visualization of conflicting calendar events, arranged in accordance with at least some embodiments described herein.

### DETAILED DESCRIPTION

As briefly described above, embodiments are directed to visualization of conflicting calendar events to enhance interactivity and prevent interaction accuracy reduction. In some examples, a number calendar events conflicting at least partially over a time period to be displayed on a calendar view may be determined based on an interactivity parameter. The interactivity parameter may include legibility, intractability, etc. If conflicting calendar events higher than the number that can be displayed is detected, an indication of more calendar events being available such as a partial calendar event display may be provided. Users may be allowed to scroll horizontally or vertically over the conflicting calendar events to see ones that are not initially displayed in a visible portion of the calendar view.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for visualization of conflicting calendar events. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

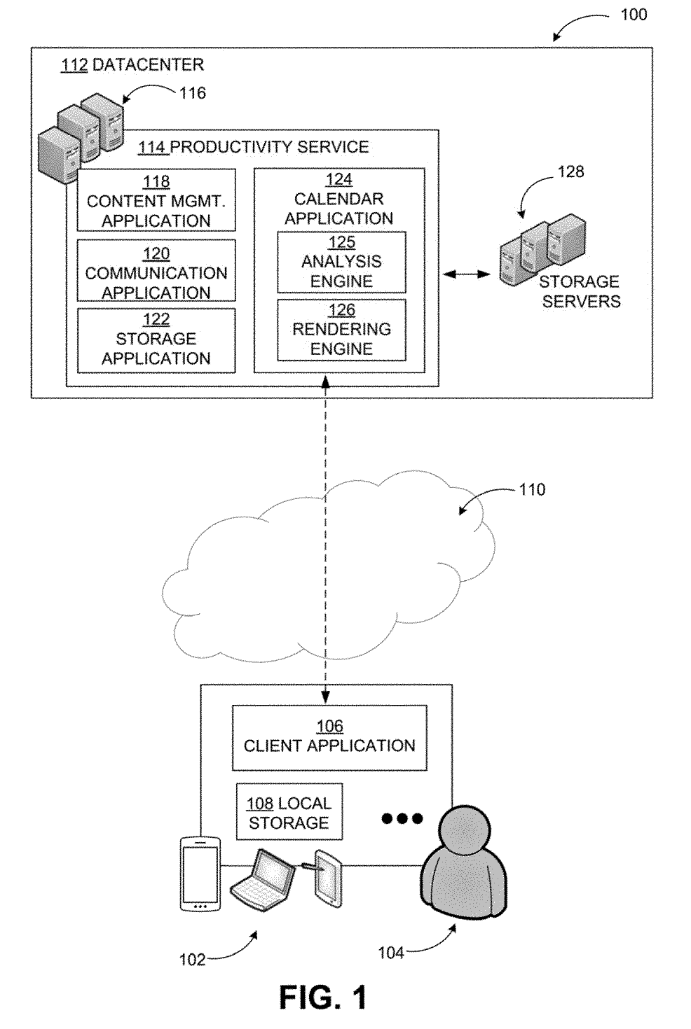

FIG. 1 includes a display diagram illustrating an example network environment where a system for visualization of conflicting calendar events may be implemented.

As illustrated in diagram 100, an example system may include a datacenter 112 executing a productivity service 114 on at least one processing server 116. The productivity service 114 may provide users various services and/or applications, including a content management application 118, a communication application 120, a storage application 122, and a calendar application 124, among other similar applications (e.g., word-processing, presentation, spreadsheet, and notebook applications), that enable users create, edit, manage, store, and share information. The productivity service 114 may be configured to interoperate with a client application 106 through one or more client devices 102 over one or more networks, such as network 110. For example, the productivity service 114 may allow a user 104 to access its services and/or applications such as the calendar application 124 through the client application 106 executed on the client devices 102. The client devices 102 may include a desktop computer, a laptop computer, a tablet computer, a vehicle-mount computer, a smart phone, or a wearable computing device, among other similar devices. In other examples, the productivity service 114 may be provided to a tenant (e.g., a business, an organization, or similar entities), which may configure and manage the services for their users. The information that is created, edited, stored, and/or shared using the various services and/or applications of the productivity service 114 may be stored locally in local storage 108 of the client devices 102 and/or remotely in storage servers 128 of the datacenter 112 (or another datacenter).

In one embodiment, as illustrated in diagram 100, the processing server 116 may be operable to execute an analysis engine 125 and a rendering engine 126 to provide automatic association and sharing of photos with calendar events, where the enrichment engine 126 may be integrated with the calendar application 124 of the productivity service 114. In another embodiment, as illustrated in diagram 100B of FIG. 1B, the content management application 118 may provide visualization of conflicting calendar events in conjunction with applications provided by the productivity service, including the calendar application 124, the communication application 120, and the storage application 122, for example.

The analysis engine 125 and the rendering engine 126 of the calendar application 124 may perform actions associated with detection of two or more calendar events that conflict over a time period and determination of a display size for the two of more conflicting calendar events based on an interactivity parameter, where the interactivity parameter defines a minimum size to legibility or interactivity, for example. The two or more calendar events may then be presented on a calendar user interface by using the determined display size, providing an indication of additional calendar event information outside a visible portion of the calendar view, and allowing a scroll action to the additional calendar event information outside a visible portion of the calendar view. As described herein, the productivity service 114, the various applications provided by the productivity service 114, the analysis engine 125, and the rendering engine 126 may be implemented as software, hardware, or combinations thereof.

Selection and/or confirmation inputs from user 104 may be received through one or more input devices communicatively coupled with one of the client devices 102. The input devices may enable a keyboard input, a mouse input, a pen input, a touch input, an optical capture, a voice input, a gyroscopic input, and/or an eye-tracking input, for example.

Users may find it difficult to read, understand, or interact with conflicting calendar events, when those are rendered in a reduced format over the same time period. The legibility of the calendar event representations on a calendar view may become even worse on smaller display areas such as mobile devices. The implementation of visualization of conflicting calendar events to enhance interactivity and prevent interaction accuracy reduction may increase user efficiency in interacting with calendar applications. Embodiments may also reduce memory, network bandwidth, and processor usage by reducing multiple interactions with individual calendar events due to illegibility or reduced interaction accuracy of reduced format conflicting calendar events.

Embodiments, as described herein, address a need that arises from a very large scale of operations created by software-based services that cannot be managed by humans. The actions/operations described herein are not a mere use of a computer, but address results of a system that is a direct consequence of software used as a service offered in conjunction with a large number of users consuming calendar services to schedule, manage, and facilitate calendar events.

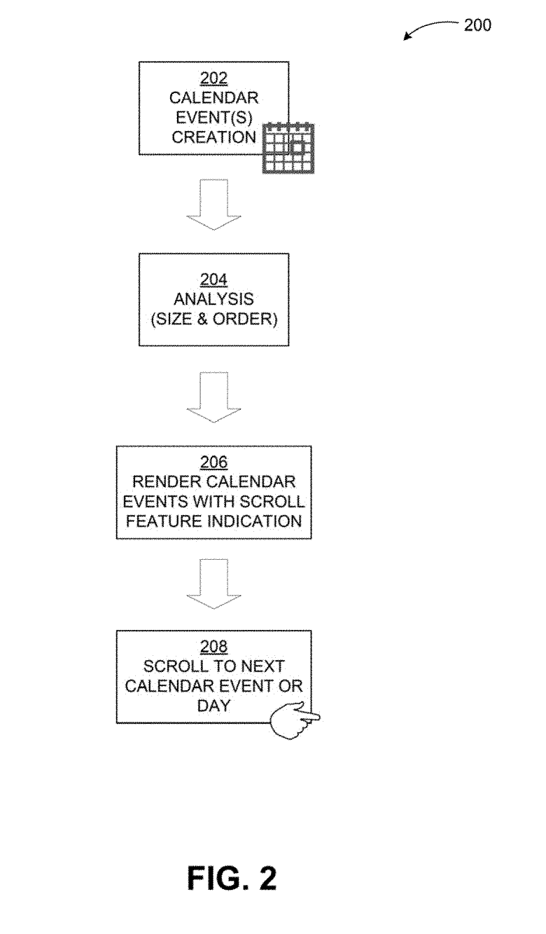

FIG. 2 includes a display diagram illustrating conceptually an example set of actions for visualization of conflicting calendar events.

As shown in diagram 200, an example process may begin with a calendar event 202 such as a physical meeting, an online meeting, an appointment, or a task being created. A calendar application, an analysis engine within the calendar application, or a comparable application or module may analyze (204) the calendar event 202. The analysis may determine a rendering size for the calendar event, whether there are more than a threshold number of calendar events that overlap (conflict), and how to present the conflicting calendar events. The determination may be based on an interactivity parameter in some examples.

The interactivity parameter may define one or more of a minimum rendering size for each calendar event and a number of legible calendar events that can be displayed over the time period, and a number of calendar events that can be displayed over the time period and allow user interaction. The interactivity parameter may also be determined based on querying an operating system of a client device displaying the calendar view and/or the calendar application rendering the calendar view. The rendering size for the two of more conflicting calendar events may also be determined based determining an available display area for the calendar view and/or a size of a display device associated with the computing device.

Next, the conflicting calendar events may be rendered with a scroll feature (206). That is, one or more of the calendar events may be partially displayed or not displayed inside a visible portion of the calendar view, but may be accessible (brought into the visible portion) through a scroll action (208). The scroll action may be received as a keyboard input, a mouse input, a pen input, a touch input, an optical capture, a voice input, a gyroscopic input, and/or an eye-tracking input. The scroll action may result in movement of the conflicting calendar events in and out of the visible portion of the calendar view or changing of the day or timeline displayed on the calendar view depending on a location of the scroll action, reaching an end of the conflicting calendar events, activation of a control element, etc. The calendar events may include a physical meeting, an online meeting, a task, or an appointment.

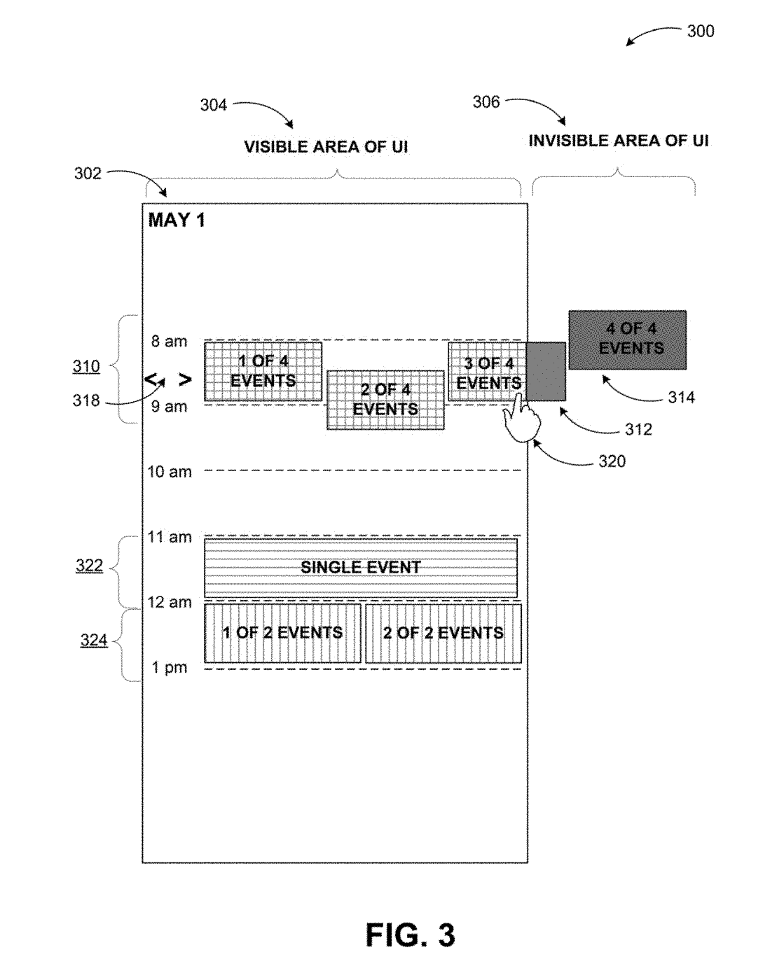

FIG. 3 includes a display diagram illustrating an example calendar user interface showing horizontal scroll based visualization of conflicting calendar events.

Diagram 300 shows an example calendar view 302 of a day with multiple calendar events. Some calendar events may be a single event 322 over a predefined time period (e.g., 1 hour, ½ hour, etc.). Other calendar events may be multiple over a predefined time period (e.g., two events 324 or four events 310). A number of calendar events to be displayed fully over a time period may be determined based on the interactivity parameter, available display area, etc. as discussed above. Thus, in an example configuration, two events 324 may be determined to be renderable on the calendar view 302 side-by-side without loss of legibility or interactivity accuracy. On the other hand, rendering four events over the same time period (or periods) may result in loss of legibility or interaction accuracy. That is event information such as title of the event, etc. may not be displayable in the small, reduced format, users may not be able to click or tap on elements or even the calendar event if the sizes of the conflicting calendar events are reduced.

In some examples, the conflicting calendar events may be presented partially with a scroll feature. That is, some of the conflicting calendar events (e.g., calendar event 314) may be rendered outside a visible area of the calendar user interface 304 in an invisible area of the calendar user interface 306 and accessible by scrolling 320. The indication of the additional calendar event information outside the visible portion of the calendar view may include an indication element 318 in proximity of the time period (e.g., inside the time period next to a border, outside the time period next to the border, or similar location as shown in the diagram). The indication may also include displaying a calendar event 312 partially at a border of the time period. Conflicting calendar events may overlap partially over the time period or they may overlap over the entire time period.

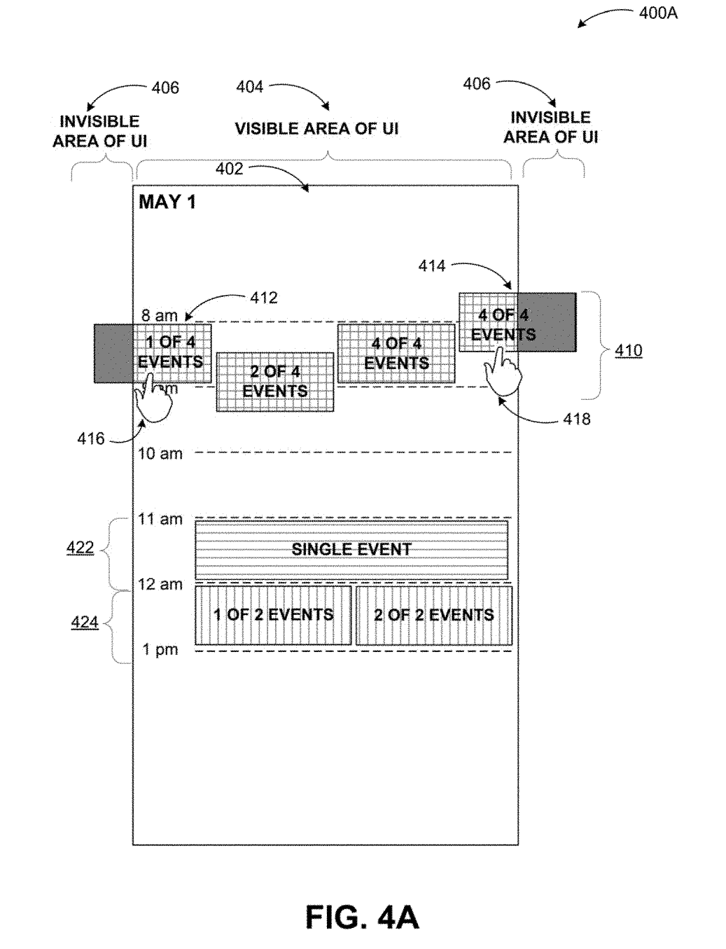

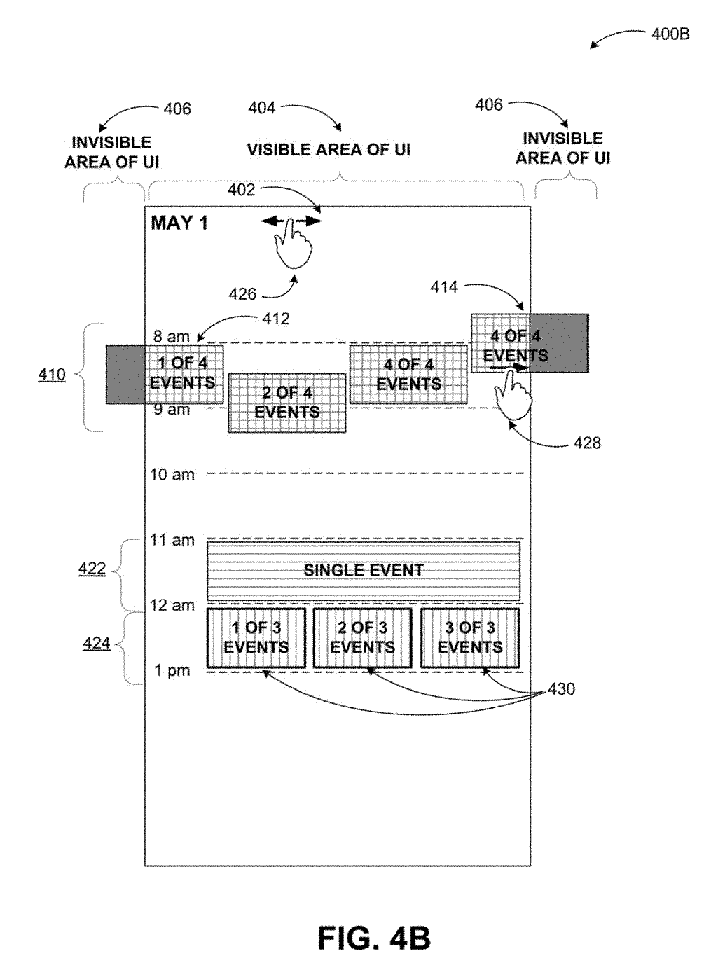

FIGS. 4A and 4B include display diagrams illustrating example calendar user interfaces with different features of horizontal scroll based visualization of conflicting calendar events.

Diagram 400A shows how conflicting calendar events 410 can be accessed (brought into view) by scrolling from the left 416 or from the right 418, accessing calendar events in invisible areas of the calendar user interface 406 and bringing them into the visible area of the calendar user interface 404. In an initial view, the conflicting calendar events may be ordered from left to right or right to left depending on a user preference, language default, etc. In yet other examples, one or two calendar events 412 and 414 may be displayed partially on the visible area of the calendar user interface 404 to indicate availability of additional conflicting calendar events. Single calendar event 422 or multiple calendar events 424 still legible in the calendar view 402 may be displayed completely as shown in FIG. 3.

Diagram 400B shows some features of a horizontal scroll configuration, where the scroll action may be allowed horizontally across the time period to bring the additional calendar event information into the visible portion of the calendar view. For example, the scroll action may be allowed in a left direction and/or a right direction as mentioned above. If the horizontal scroll action is above or below the time period (conflicting events 410) such as scroll action 426, the displayed day may be changed on the calendar view. If the horizontal scroll action 428 reaches an end the additional calendar information in an invisible portion of the calendar view, the displayed day may again be changed on the calendar view. In other examples, the scroll action may be allowed vertically across the time period to bring the additional calendar event information into the visible portion of the calendar view.

Diagram 400B also shows three conflicting events 430 over time period 424. Depending on the display size (e.g. a desktop or laptop computer) and/or available display area for the calendar application view 402, a larger or smaller number of conflicting events may be display completely over the same time period. The determination of the number of conflicting calendar events and sizes of the calendar events to be displayed may be made statically or dynamically upon changes in any of the parameters or user preference.

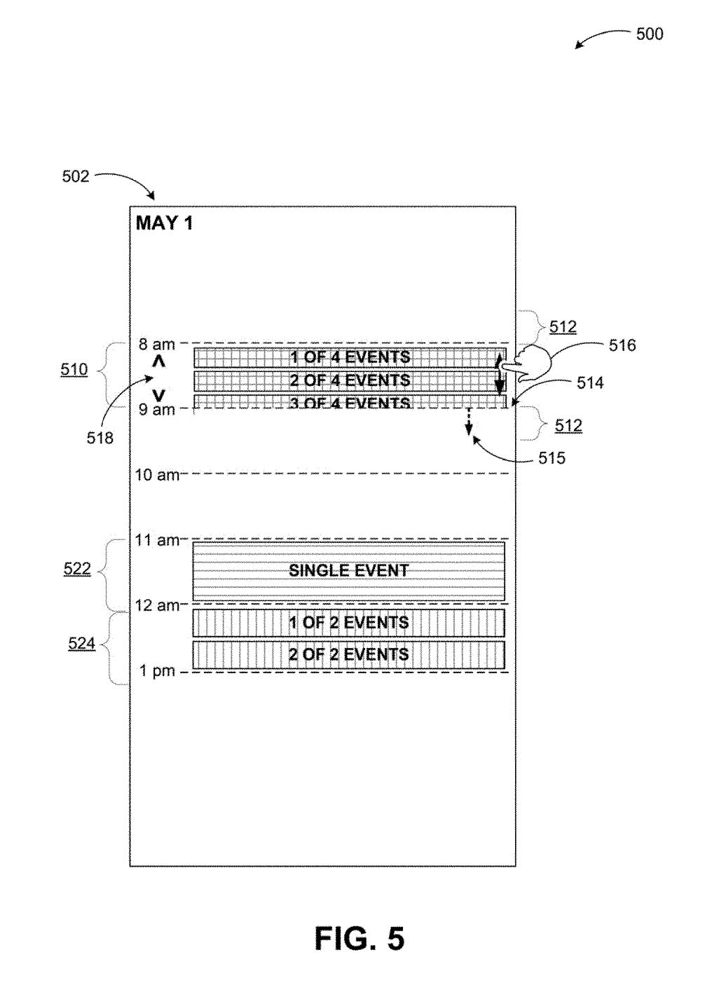

FIG. 5 includes a display diagram illustrating an example calendar user interface showing vertical scroll based visualization of conflicting calendar events.

Diagram 500 shows a calendar view 502 with single (522) and multiple (524) event periods, where the conflicting events may be displayed without loss of legibility or interactivity accuracy. On the other hand, the number of conflicting calendar events 510 over a time period may exceed the number to display legibly and the conflicting calendar events may be displayed partially as discussed herein, but in vertical order. An indication element 518 or partial vertical display of an event 514 may indicate availability of additional calendar events, which may be accessed through a vertical scroll action 516 within the time period. The vertical scroll action 516 may bring calendar events in to view up or down from invisible portions 512 of the calendar view (which may be hidden behind displayed visible portions such as other time periods). A scroll action 515 outside the time period with conflicting calendar events may result in a scrolling of the timeline.

An order of the conflicting calendar events (horizontally left-to-right or right-to-left, or vertically downwards or upwards) may be determined based on one of a creation order, a type, and user preference. In further examples, an analysis engine of the calendar application may make an inference on importance of individual calendar events for a user. For example, a meeting with a supervisor may be determined to be more important than joining a conference call as a listener, a doctor's appointment may be more important than a yoga session, etc. The analysis engine may then determine an order of the conflicting calendar events based on the inference.

The examples provided in FIGS. 1 through 5 are illustrated with specific systems, services, applications, and user interface displays. Embodiments are not limited to environments according to these examples. Visualization of conflicting calendar events may be implemented in environments employing fewer or additional systems, services, applications, and user interface displays. Furthermore, the example systems, services, applications, and user interface displays shown in FIGS. 1 through 5 may be implemented in a similar manner with other user interface or action flow sequences using the principles described herein.

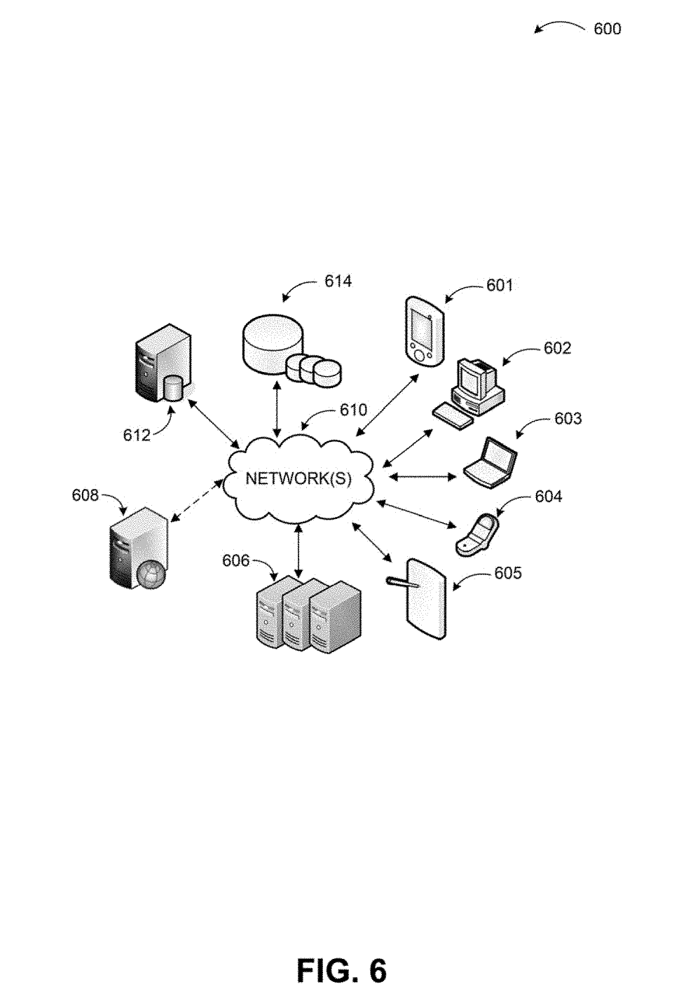

FIG. 6 is a networked environment, where a system according to embodiments may be implemented.

Visualization of conflicting calendar events as described herein may be employed in conjunction with hosted applications and services (for example, the calendar application 124 associated with the productivity service 114, the client application 106 associated with the productivity service 114, various other applications associated with the productivity service 114, content management application 118) that may be implemented via software executed over one or more servers 606 or individual server 608, as illustrated in diagram 600. A hosted service or application may communicate with client applications on individual computing devices such as a handheld computer 601, a desktop computer 602, a laptop computer 603, a smart phone 604, a tablet computer (or slate), 605 (‘client devices’) through network(s) 610 and control a user interface presented to users.

Client devices 601-605 are used to access the functionality provided by the hosted service or client application. One or more of the servers 606 or server 608 may be used to provide a variety of services as discussed above. Relevant data may be stored in one or more data stores (e.g. data store 614), which may be managed by any one of the servers 606 or by database server 612.

Network(s) 610 may comprise any topology of servers, clients, Internet service providers, and communication media. A system according to embodiments may have a static or dynamic topology. Network(s) 610 may include a secure network such as an enterprise network, an unsecure network such as a wireless open network, or the Internet. Network(s) 610 may also coordinate communication over other networks such as PSTN or cellular networks. Network(s) 610 provides communication between the nodes described herein. By way of example, and not limitation, network(s) 610 may include wireless media such as acoustic, RF, infrared and other wireless media.

Many other configurations of computing devices, applications, engines, data sources, and data distribution systems may be employed to implement visualization of conflicting calendar events. Furthermore, the networked environments discussed in FIG. 6 are for illustration purposes only. Embodiments are not limited to the example applications, engines, or processes.

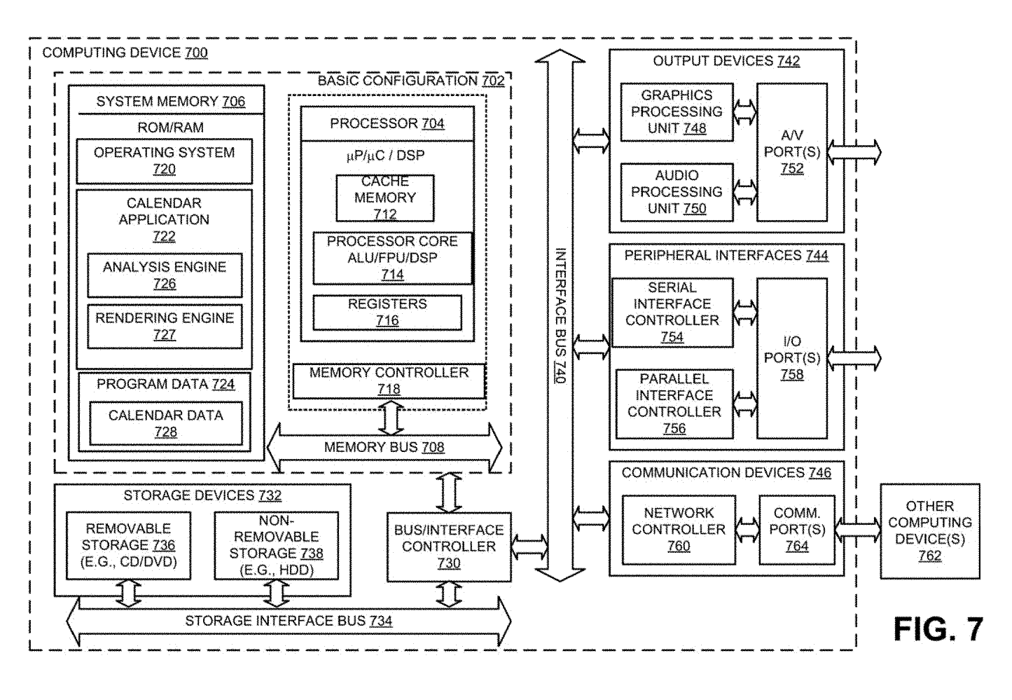

FIG. 7 is a block diagram of an example computing device, which may be used for visualization of conflicting calendar events.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, a calendar application 722, and program data 724. The calendar application 722 may include an analysis engine 726 and a rendering engine 727, which may be integrated modules of the calendar application 722. The analysis engine 726 and the rendering engine 727 may be configured to detect two or more calendar events that conflict over a time period. A display size for the two of more conflicting calendar events may be determined based on an interactivity parameter, where the interactivity parameter defines a minimum size to legibility or interactivity, for example. The two or more calendar events may then be presented on a calendar user interface by using the determined display size, providing an indication of additional calendar event information outside a visible portion of the calendar view, and allowing a scroll action to the additional calendar event information outside a visible portion of the calendar view. The program data 724 may include, among other data, calendar data 728, as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 746 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to implement visualization of conflicting calendar events to enhance interactivity and prevent interaction accuracy reduction. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

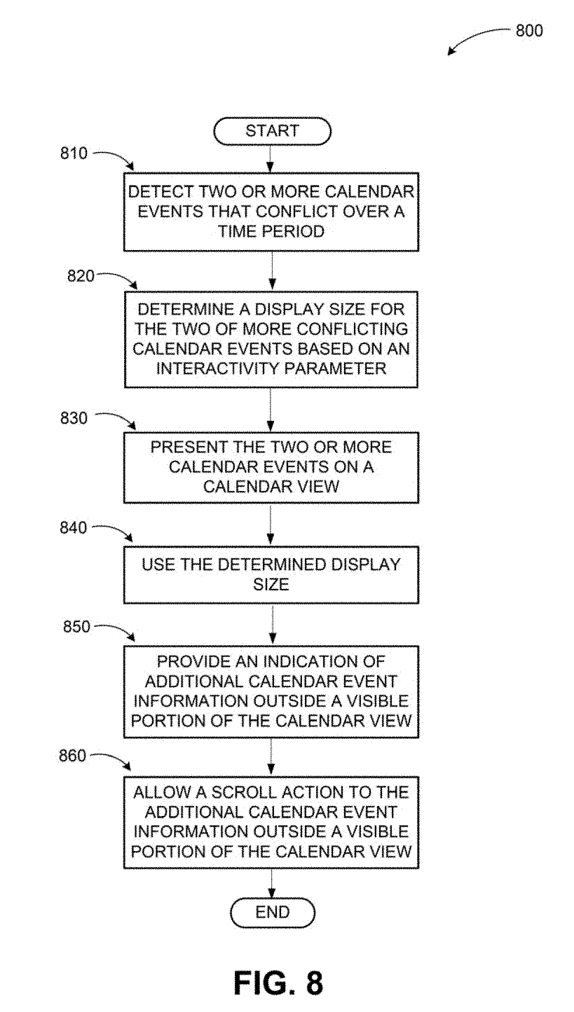

FIG. 8 illustrates a logic flow diagram of a method to implement visualization of conflicting calendar events to enhance interactivity and prevent interaction accuracy reduction.

Process 800 may be implemented on a computing device, server, or other system. An example server configured to execute an analysis engine and a rendering engine associated with a calendar application may comprise a communication interface to facilitate communication between the server and one or more client devices. The example server may also comprise a memory to store instructions, and one or more processors coupled to the memory. The processors, in conjunction with the instructions stored on the memory, may be configured to provide visualization of conflicting calendar events.

Process 800 begins with operation 810, where the processors may be configured to detecting two or more calendar events that conflict over a time period. At operation 820, the processors may be configured to determine a display size for the two of more conflicting calendar events based on an interactivity parameter. The interactivity parameter may define a number of legible calendar events that can be displayed over the same time period, the number of calendar events that can be displayed over the same time period and allow interaction (e.g., click or tap on event information, controls, etc.).

At operation 830, the processors may be configured to display the two or more calendar events on a calendar view in a scrollable fashion, where the determined display size is used at operation 840, an indication of additional calendar event information outside a visible portion of the calendar view is provided at operation 850, and a scroll action to the additional calendar event information outside a visible portion of the calendar view is allowed at operation 860.

The operations included in process 800 are for illustration purposes. Providing visualization of conflicting calendar events may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for visualizing conflicting calendar events is described. The means may include a means for detecting two or more calendar events that conflict over a time period; a means for determining a rendering size for the two of more conflicting calendar events based on an interactivity parameter; and a means for presenting the two or more calendar events on a calendar view. The two or more calendar events may be presented by a means for using the determined rendering size, a means for providing an indication of additional calendar event information outside a visible portion of the calendar view, and a means for allowing a scroll action to the additional calendar event information outside the visible portion of the calendar view, where the two or more conflicting calendar events are moved within the time period in response to the scroll action independent of other calendar events on the calendar view.

According to some examples, a method executed on a computing device to visualize conflicting calendar events is described. The method may include detecting two or more calendar events that conflict over a time period; determining a rendering size for the two of more conflicting calendar events based on an interactivity parameter; and presenting the two or more calendar events on a calendar view. The two or more calendar events may be presented by using the determined rendering size, providing an indication of additional calendar event information outside a visible portion of the calendar view, and allowing a scroll action to the additional calendar event information outside the visible portion of the calendar view, where the two or more conflicting calendar events are moved within the time period in response to the scroll action independent of other calendar events on the calendar view.

According to other examples, the interactivity parameter may define one or more of a minimum rendering size for each calendar event and a number of legible calendar events that can be displayed over the time period, and a number of calendar events that can be displayed over the time period and allow user interaction. Determining the rendering size for the two of more conflicting calendar events may include determining an available display area for the calendar view; and determining a size of a display device associated with the computing device. Allowing the scroll action to the additional calendar event information outside the visible portion of the calendar view may include allowing the scroll action horizontally across the time period to bring the additional calendar event information into the visible portion of the calendar view. The scroll action may be allowed in one or more of a left direction and a right direction.

According to further examples, the method may also include if the horizontal scroll action is above or below the time period, changing a displayed day on the calendar view. The method may further include if the horizontal scroll action reaches an end the additional calendar information in an invisible portion of the calendar view, changing a displayed day on the calendar view. Allowing the scroll action to the additional calendar event information outside the visible portion of the calendar view may also include allowing the scroll action vertically across the time period to bring the additional calendar event information into the visible portion of the calendar view. Providing the indication of the additional calendar event information outside the visible portion of the calendar view may include displaying a calendar event partially at a border of the time period. Providing the indication of the additional calendar event information outside the visible portion of the calendar view may include providing an indication element in proximity of the time period.

According to other examples, a server configured to implement visualization of conflicting calendar events is described. The server may include a communication interface configured to facilitate communication between the server, another server, and one or more client devices; a memory configured to store instructions; and one or more processors coupled to the communication interface and the memory. The one or more processors may detect two or more calendar events that conflict over a time period; determine a rendering size for the two of more conflicting calendar events based on an interactivity parameter, where the interactivity parameter defines one or more of a minimum rendering size for each calendar event and a number of legible calendar events that can be displayed over the time period, and a number of calendar events that can be displayed over the time period and allow user interaction; and provide the two or more calendar events to be displayed on a calendar view by using the determined rendering size, presenting a calendar event partially at a border of the time period to indicate availability of additional calendar event information outside a visible portion of the calendar view, and allowing a scroll action to bring the additional calendar event information inside the visible portion of the calendar view.

According to some examples, the two or more conflicting calendar events may be moved within the time period in response to the scroll action independent of other calendar events on the calendar view. The two or more conflicting calendar events may overlap partially or entirely over the time period. The one or more processors may be further configured to select an order of the two or more conflicting calendar events based on one of a creation order, a type, and user preference. The one or more processors may be further configured to determine the interactivity parameter based on querying one or more of an operating system of a client device displaying the calendar view and a calendar application rendering the calendar view. The scroll action may be based on one or more of a keyboard input, a mouse input, a pen input, a touch input, an optical capture, a voice input, a gyroscopic input, and an eye-tracking input.

According to further examples, a computer-readable memory device with instructions stored thereon for visualization of conflicting calendar events is described, where the instructions are configured to cause actions when executed on a computing device. The actions may include detecting two or more calendar events that conflict over a time period; determining a rendering size for the two of more conflicting calendar events based on an interactivity parameter, where the interactivity parameter defines one or more of a minimum rendering size for each calendar event and a number of legible calendar events that can be displayed over the time period, and a number of calendar events that can be displayed over the time period and allow user interaction; and providing the two or more calendar events to be displayed on a calendar view by using the determined rendering size, presenting a calendar event partially at a border of the time period to indicate availability of additional calendar event information outside a visible portion of the calendar view, and allowing a left direction or right direction horizontal scroll action to bring the additional calendar event information inside the visible portion of the calendar view independent of other calendar events on the calendar view.

According to yet other examples, the actions may include making an inference on importance of the two or more calendar events to a user, and ordering the two or more calendar events on the time period based on the inference. The actions may also include determining one or more of a number of calendar events to display on the time period and a size of the calendar events to display dynamically based on a device type and an available display area for the calendar view. The two or more calendar events may one or more of a physical meeting, an online meeting, a task, and an appointment.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to visualize conflicting calendar events, the method comprising:
detecting two or more calendar events that conflict over a time period;
determining a rendering size for the two of more conflicting calendar events based on an interactivity parameter, and
presenting the two or more calendar events on a calendar view by:
using the determined rendering size,
providing an indication of additional calendar event information outside a visible portion of the calendar view, and
allowing a scroll action to the additional calendar event information outside the visible portion of the calendar view, wherein the two or more conflicting calendar events are moved within the time period in response to the scroll action independent of other calendar events on the calendar view.

2. The method of claim 1, wherein the interactivity parameter defines one or more of a minimum rendering size for each calendar event and a number of legible calendar events that can be displayed over the time period, and a number of calendar events that can be displayed over the time period and allow user interaction.

3. The method of claim 1, wherein determining the rendering size for the two of more conflicting calendar events comprises:
determining an available display area for the calendar view; and
determining a size of a display device associated with the computing device.

4. The method of claim 1, wherein allowing the scroll action to the additional calendar event information outside the visible portion of the calendar view comprises:
allowing the scroll action horizontally across the time period to bring the additional calendar event information into the visible portion of the calendar view.

5. The method of claim 4, wherein the scroll action is allowed in one or more of a left direction and a right direction.

6. The method of claim 4, further comprising:
if the horizontal scroll action is above or below the time period, changing a displayed day on the calendar view.

7. The method of claim 4, further comprising:
if the horizontal scroll action reaches an end the additional calendar information in an invisible portion of the calendar view, changing a displayed day on the calendar view.

8. The method of claim 1, wherein allowing the scroll action to the additional calendar event information outside the visible portion of the calendar view comprises:
allowing the scroll action vertically across the time period to bring the additional calendar event information into the visible portion of the calendar view.

9. The method of claim 1, wherein providing the indication of the additional calendar event information outside the visible portion of the calendar view comprises:
displaying a calendar event partially at a border of the time period.

10. The method of claim 1, wherein providing the indication of the additional calendar event information outside the visible portion of the calendar view comprises:
providing an indication element in proximity of the time period.

11. A server configured to implement visualization of conflicting calendar events, the server comprising:
a communication interface configured to facilitate communication between the server, another server, and one or more client devices;
a memory configured to store instructions; and
one or more processors coupled to the communication interface and the memory, the one or more processors configured to:
detect two or more calendar events that conflict over a time period;
determine a rendering size for the two of more conflicting calendar events based on an interactivity parameter, wherein the interactivity parameter defines one or more of a minimum rendering size for each calendar event and a number of legible calendar events that can be displayed over the time period, and a number of calendar events that can be displayed over the time period and allow user interaction; and
provide the two or more calendar events to be displayed on a calendar view by:
using the determined rendering size,
presenting a calendar event partially at a border of the time period to indicate availability of additional calendar event information outside a visible portion of the calendar view, and
allowing a scroll action to bring the additional calendar event information inside the visible portion of the calendar view.

12. The server of claim 11, wherein the two or more conflicting calendar events are moved within the time period in response to the scroll action independent of other calendar events on the calendar view.

13. The server of claim 11, wherein the two or more conflicting calendar events overlap partially or entirely over the time period.

14. The server of claim 11, wherein the one or more processors are further configured to select an order of the two or more conflicting calendar events based on one of a creation order, a type, and user preference.

15. The server of claim 11, wherein the one or more processors are further configured to determine the interactivity parameter based on querying one or more of an operating system of a client device displaying the calendar view and a calendar application rendering the calendar view.

16. The server of claim 11, wherein the scroll action is based on one or more of a keyboard input, a mouse input, a pen input, a touch input, an optical capture, a voice input, a gyroscopic input, and an eye-tracking input.

17. A computer-readable memory device with instructions stored thereon for visualization of conflicting calendar events, the instructions configured to cause actions when executed on a computing device, the actions comprising:
detecting two or more calendar events that conflict over a time period;
determining a rendering size for the two of more conflicting calendar events based on an interactivity parameter, wherein the interactivity parameter defines one or more of a minimum rendering size for each calendar event and a number of legible calendar events that can be displayed over the time period, and a number of calendar events that can be displayed over the time period and allow user interaction; and
providing the two or more calendar events to be displayed on a calendar view by:
using the determined rendering size,
presenting a calendar event partially at a border of the time period to indicate availability of additional calendar event information outside a visible portion of the calendar view, and
allowing a left direction or right direction horizontal scroll action to bring the additional calendar event information inside the visible portion of the calendar view independent of other calendar events on the calendar view.

18. The computer-readable memory device of claim 17, wherein the actions further comprise:
making an inference on importance of the two or more calendar events to a user; and
ordering the two or more calendar events on the time period based on the inference.

19. The computer-readable memory device of claim 17, wherein the actions further comprise:
determining one or more of a number of calendar events to display on the time period and a size of the calendar events to display dynamically based on a device type and an available display area for the calendar view.

20. The computer-readable memory device of claim 17, wherein the two or more calendar events include one or more of a physical meeting, an online meeting, a task, and an appointment.
